(19) United States
(12) Patent Application Publication
(10) Pub. No.: US 2006/0014128 A1
(43) Pub. Date: Jan. 19, 2006

(54) Musical training apparatus with lesson scheduler

(75) Inventor: Shigehiko Mizuno, Hamamatsu-shi (JP)

Correspondence Address: ROSSI, KIMMS & McDOWELL LLP., P.O. BOX 826, ASHBURN, VA, 20146-0826, US

(73) Assignee: Yamaha Corporation, Hamamatsu-shi (JP)

(21) Appl. No.: 11/176,970

(22) Filed: Jul. 7, 2005

(30) Foreign Application Priority Data
Jul. 7, 2004 (JP) 2004-201067

(51) Int. Cl. G09B 7/00; G09B 5/00

(52) U.S. Cl. 434/307 R; 434/362

(57) ABSTRACT

A musical training apparatus comprises a schedule managing device and a schedule notifying device. The schedule managing device manages a schedule database which includes lesson matter information representing lesson matters of musical lesson course and lesson time information representing times to take lessons of the respective lesson matters. Each lesson time is assigned to each corresponding lesson matter for a user. At a predetermined time point in advance of the scheduled lesson time for a user to take the scheduled lesson matter, the lesson schedule notifying device notifies a reminder of the lesson to a user terminal device. The user can request a change in the schedule from the user terminal device or by the setting controls on the apparatus.

### TECHNICAL FIELD

The present invention relates to a musical training apparatus incorporating a lesson scheduler and a computer program therefor, and more particularly to a musical training apparatus and a computer program capable of managing the lesson schedule for the user, including arranging, changing and notifying the lesson schedule so that the user may diligently take the scheduled lessons to enhance his/her musical skill.

### BACKGROUND INFORMATION

Various types of musical training apparatuses such as electronic musical instruments having a function of giving lessons to a trainee are heretofore known in the art. An example of such musical training apparatuses is disclosed in unexamined Japanese patent publication No. 2003-150154, in which a curriculum instructing a procedure of learning how to play an electronic musical instrument is stored in a personal digital assistant terminal in a manner that the curriculum can be edited on the terminal and can be transmitted to an electronic musical instrument so that a user can arrange what and how to learn toward an aimed goal, and in which the training apparatus can lead the user in a manner that will meet the progress steps of the user under training.

With such a conventional apparatus or system, however, when to take lessons actually has been managed on the side of the user who trains himself/herself in playing a musical instrument. Thus, a user or trainee who can manage himself/herself will take lessons diligently and make good progress, whereas a user who is not good at managing himself/herself will sometimes take lessons and sometimes not and make little progress in the skill of playing a musical instrument.

### SUMMARY OF THE INVENTION

It is, therefore, a primary object of the present invention to solve the drawbacks with the conventional apparatus, and to provide a novel type of musical training apparatus and a computer program, which can urge even the users who are not good at managing themselves in taking musical lessons to take lessons as scheduled.

According to the present invention, the object is accomplished by providing a musical training apparatus comprising: a schedule managing device for managing a schedule database including lesson matter information representing lesson matters of musical lesson courses and lesson time information representing times to take lessons of the respective lesson matters in the form of a relational database, wherein each lesson time is assigned to each corresponding lesson matter for a user; and a lesson schedule notifying device for notifying to a user terminal device a reminder of a scheduled lesson matter and the scheduled lesson time for the user to take the scheduled lesson matter at a predetermined time in advance of the scheduled lesson time as represented by the lesson time information. Thus, the user will not forget to take the scheduled lessons.

In an aspect of the present invention, the schedule managing device may modify the schedule database in accordance with a progress state of the musical lesson course by the user. Thus, the lesson matters which have not been taken yet will not be skipped, and also the lesson matters which have already been taken will not be presented redundantly.

In a further aspect of the present invention, the schedule managing device may modify the schedule database in accordance with a request from the user terminal device. Thus, the user can request changes in the lesson schedules from the user terminal devices so that the user can take the respective lesson matters at his/her convenient times.

According to the present invention, the object is further accomplished by providing a computer readable medium containing executable instructions for causing a computer to perform a method for managing schedule of lessons for musical training by a user, the method comprising the steps of: providing a schedule database including lesson matter information representing lesson matters of musical lesson courses and lesson time information representing times to take lessons of the respective lesson matters in the form of a relational database, wherein each lesson time is assigned to each corresponding lesson matter for a user; and notifying to a user terminal device a reminder of a scheduled lesson matter and the scheduled lesson time for the user to take the scheduled lesson matter at a predetermined time in advance of the scheduled lesson time as represented by the lesson time information. Thus, a computer will remind the user not to forget to take the scheduled lessons.

As is apparent from the above description, the present invention can be practiced not only in the form of an apparatus, but also in the form of a computer program to operate a computer or other data processing devices. The invention can further be practiced in the form of a method including the steps mentioned herein.

In addition, as will be apparent from the description herein later, some of the structural element devices of the present invention are structured by means of hardware circuits, while some are configured by a computer system performing the assigned functions according to the associated programs. The former may of course be configured by a computer system and the latter may of course be hardware structured discrete devices. Therefore, a hardware-structured device performing a certain function and a computer-configured arrangement performing the same function should be considered a same-named device or an equivalent to the other.

### BRIEF DESCRIPTION OF THE DRAWINGS

For a better understanding of the present invention, and to show how the same may be practiced and will work, reference will now be made, by way of example, to the accompanying drawings, in which:

FIG. 1 is a block diagram illustrating the overall hardware configuration of a musical training system according to an embodiment of the present invention;

FIG. 2 is a functional block diagram illustrating the overall configuration and operation of a musical training system according to an embodiment of the present invention;

FIG. 3 shows the contents of an example of the schedule database incorporated in a musical training system according to an embodiment of the present invention;

FIGS. 4a and 4b show examples of the lesson schedule notice issued in a musical training system according to an embodiment of the present invention;

FIG. 5 shows an example of the e-mail requesting a modification of a lesson schedule transmitted in a musical training system according to an embodiment of the present invention;

FIGS. 6a and 6b show examples of the modified schedule notice issued in a musical training system according to an embodiment of the present invention; and

FIG. 7 is a flow chart describing an example of the schedule control processing conducted by a musical training system according to an embodiment of the present invention.

### DETAILED DESCRIPTION OF EMBODIMENTS OF THE INVENTION

The present invention will now be described in detail with reference to the drawings showing a preferred embodiment thereof. It should, however, be understood that the illustrated embodiments are merely examples for the purpose of understanding the invention, and should not be taken as limiting the scope of the invention.

System Configuration

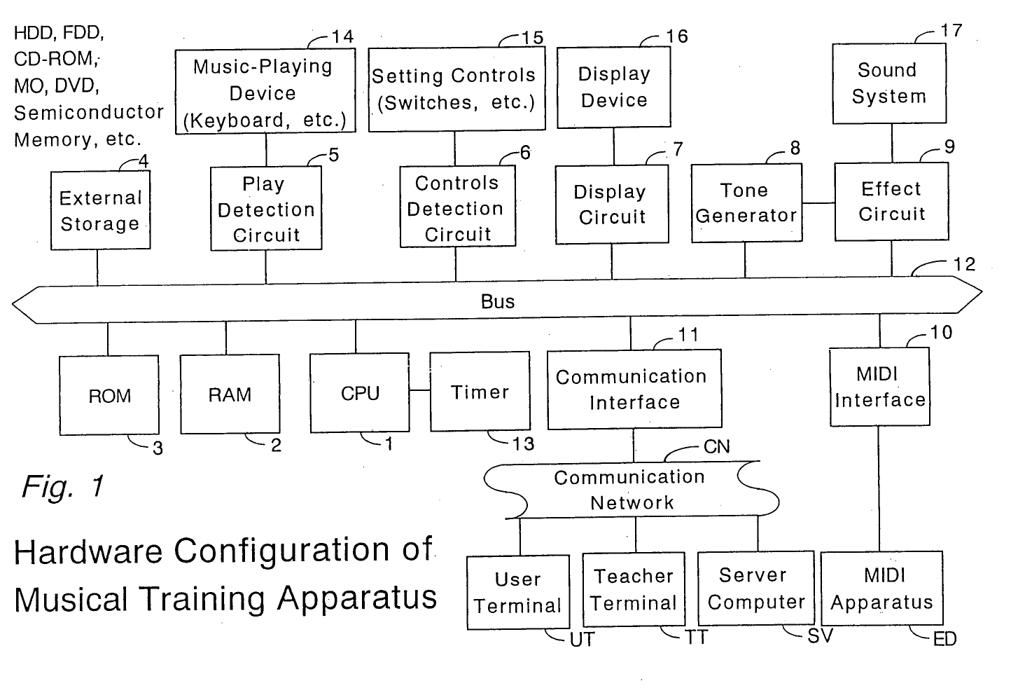

FIG. 1 shows a block diagram illustrating the overall hardware configuration of a musical training system according to an embodiment of the present invention. A musical training apparatus MT as a main setup of the system, and may be built in the form of an electronic musical instrument (including a computer) which is a data processing apparatus dedicated for musical data processing, but may also be arranged by a general purpose data processing apparatus such as a personal computer (PC) equipped with a music playing input device and a musical tone generating function. The musical training apparatus MT comprises a central processing unit (CPU) 1, a random access memory (RAM) 2, a read-only memory (ROM) 3, an external storage device 4, a play detection circuit 5, a controls detection circuit 6, a display circuit 7, a tone generator circuit 8, an effect circuit 9, a MIDI interface 10 and a communication interface 11, all of which are connected with each other by a system bus 12.

The CPU 1 conducts various musical data processing including musical lesson execution according to a given control program utilizing a clock signal from a timer 13. The RAM 2 is used as work areas for temporarily store various data during the processing. The ROM 3 stores beforehand various control programs including the musical lesson program and various data and parameters for the execution of the processing.

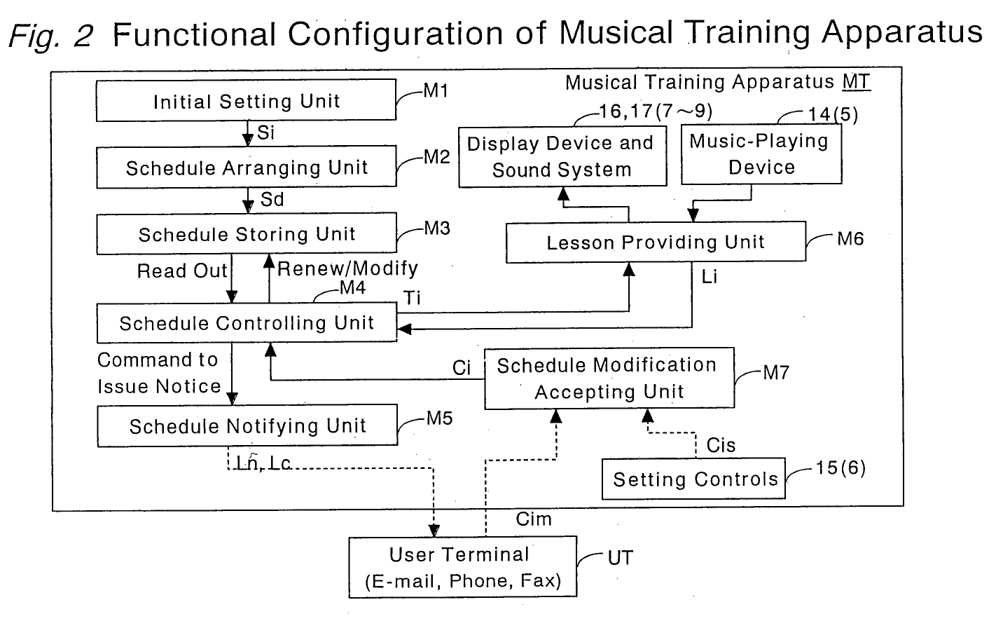

The external storage device 4 may include a built-in storage medium such as a hard disk (HD) as well as various portable external storage media such as a compact disk read-only memory (CD-ROM), a flexible disk (FD), magneto-optical (MO) disk, a digital versatile disk (DVD), a small-sized memory card like Smart Media (trademark) and so forth. For example, a predetermined area in the hard disk may be used as a storage device of a schedule storing unit M3 (FIG. 2).

The play detection circuit 5 detects the user's operations of a music-playing device 14 such as a keyboard and a wheel, and the control detection circuit 6 detects the user's operations of the setting controls 15 such as key switches and a mouse device. The both detection circuits 5 and 6 introduce the information (data) of the detected operations into the musical training system. The setting controls 15 further include, for example, a control for directing the start of a music training lesson (may be called “performance lesson” or “music-playing lesson”) and a control for directing a request for modifying the lesson schedule.

The display circuit 7 is connected to a display device 16 including a display screen (CRT, LCD or else) for displaying various images and pictures, guide lamps (LED, etc.) and various indicators, and controls the displayed contents and lighting conditions of the display these devices according to instructions from the CPU 1 and also presents GUIs for assisting the user in operating the various controls 15 and the music-playing device 14. For example, while the user is taking a music-playing lesson, the screen of the display device 16 may present a music score and/or a keyboard pattern together with a moving cursor or color change to guide which note and/or key to play, or guide lamps provided by the individual keys on the music-playing device 14 may be lit to instruct the user the keys to be played, or a music score may be displayed with guiding descriptions and/or marks or a guidance for playing may be presented in accordance with the lesson matters to take.

The tone generator circuit 8 generates musical tone signals as determined by the musical tone data obtained from the processing of the performance data (i.e. music-playing data) given by the music-playing device 14 and/or the memories 2, 3 and the storage device 4. The effect circuit 9 includes an effect imparting DSP (digital signal processor) and imparts intended tone effects to the musical tone signals outputted from the tone generator circuit 8 and/or the audio data outputted from the other portions of the apparatus. To the effect circuit 9 is connected a sound system 17, which includes a D/A converter, an amplifier and a loudspeaker, and emits audible sounds based on the effect imparted musical tone signals and audio data signals.

To the MIDI interface 10 is connected a MIDI apparatus ED such as another electronic musical instrument, so that musical performance data including the actually (real-time) played music data are exchanged in this system between the musical training apparatus and the other MIDI apparatus ED.

The communication interface 11 is further connected to a communication network CN such as a local area network (LAN), the Internet or wireless communication network, so that external stations such as server computer SV, a teacher terminal TT, a user terminal UT, etc. can be connected to this musical training system. For example, various data files including control program files and performance data files can be downloaded from the external server computer SV to the musical training apparatus MT and can be stored in the external storage device 4 for the repeated internal use in the future.

The teacher terminal TT is a musical data processing apparatus having a communication function just like the music training apparatus MT of this system, and can receive and transmit data necessary for conducting a musical lesson on the musical training apparatus MT. The user terminal UT (sometimes may be called an e-mail terminal) is a portable (mobile) communication terminal device such as a cellphone having an e-mailing function, and can receive and transmit data relating to the musical lesson schedule.

Musical Lesson Function of the Overall System

A musical training system according to an embodiment of the present invention manages the musical lesson matters and the times and days for the lessons as the related schedule data, and sends to a user terminal a notice of a scheduled lesson at the time which is prior to the scheduled lesson time by a predetermined amount of time length, thereby reminding the user of the coming lesson not to forget to take the scheduled lesson. FIG. 2 shows a general functional block diagram illustrating the overall configuration and operation of a musical training system according to an embodiment of the present invention.

Referring now to FIG. 2, the characteristic feature of the music training system of this embodiment will be roughly described first. In this training system, the music training apparatus MT comprises a schedule controlling unit M4 which manages musical lesson matters (or items) and the times (dates and hours) for the respective lessons as a relational schedule database Sd. As it comes to the time which is a predetermined time before the lesson time (A) in the schedule data Sd, the apparatus MT issues a lesson schedule notice Ln to the user terminal UT of the scheduled trainee, reminding the trainee to take the scheduled musical lesson (B) at the scheduled time (A). As a lesson providing unit M6 conducts the lesson, the schedule controlling unit M4 automatically renews the schedule data Sd according to the lesson progress state represented by the lesson progress information Li from the lesson providing unit M6, so that the trainee can further proceed with the musical training lesson properly. In addition, when a schedule modification accepting unit M7 receives an e-mail Cim requesting a modification of a lesson schedule from the user terminal UT, the schedule modification accepting unit M7 sends a request information signal Ci representing the content of the modification requesting e-mail Cim to the schedule controlling unit M4, which in turn changes the content of the schedule data Sd according to the content (e.g. a lesson time convenient to the user) of the request information signal Ci.

The function of the music training apparatus MT will be described in more detail herein-below. The music training apparatus MT comprises organically configured function blocks such as an initial setting unit M1, a schedule arranging unit M2, a schedule storing unit M3, the above described schedule controlling unit M4, a schedule notifying unit M5, the above described lesson providing unit M6 and the above described schedule modification accepting unit M7 as shown in FIG. 2.

The initial setting unit M1 is a function block which conducts initial setting for the musical lessons. For example, specific information about various setting items such as lesson starting dates, lesson frequencies, lesson times, lesson contents (matters, courses, etc.) are inputted to generate set item information Si representing the contents as initially set.

The lesson starting date represents the day on which the user of this musical training apparatus MT starts the musical training lesson. The lesson frequency represents how often the user will take the lessons, for example, “every day,” “once per three days,” “once a week,” and so forth. The lesson time which may be called a lesson date and hour represents the date and the hour at which the user should take the lesson in terms of, for example, the day of the week (or the day of a month) and the hour of the day. The lesson contents include the course rank according to the musical skill level such as a beginner's course, a middle course and an advanced course, and the number of lesson steps in each course as well as the contents of the training (training information Ti) such as music contents and lesson programs which are used in the musical lesson in the respective courses and steps. In case the musical training apparatus MT is used by a plurality of users for taking music-playing lessons, the items in the set item information Si may be set individually for each of the users.

The schedule arranging unit M2 is a function block which arranges or composes a basic lesson schedule according to the set item information Si as set in the manner described above. For example, where the beginners' course consists of ten steps of lessons, a date and hour is set for taking lesson of each of the ten steps and the set contents are arranged in the order of the set date and hour (i.e. the order of the step numbers) to make the schedule data Sd. The schedule data Sd may be stored independently for each of the users.

The schedule storing unit M3 is a function block which stores the schedule data Sd as arranged by the schedule arranging unit M2. The schedule data Sd may be stored, for example, in a predetermined storage area provided in a hard disk of the external storage device 4, and in the same storage area may be also stored the contents of the training (training information Ti) which correspond to the schedule data Sd.

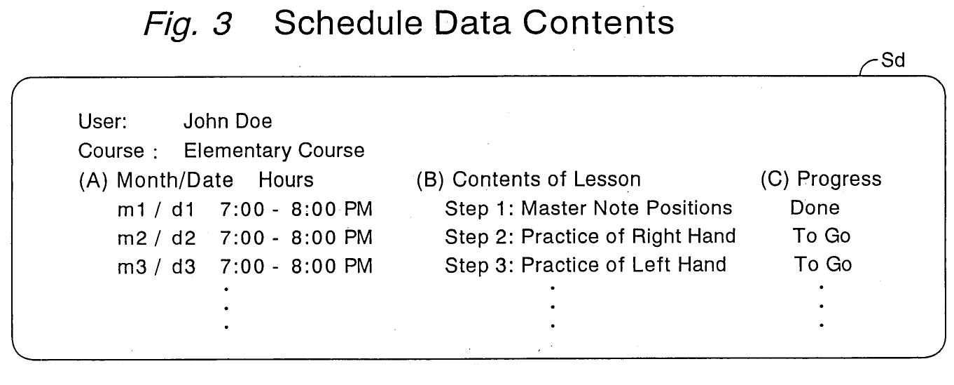

FIG. 3 shows the contents of an example of the schedule database Sd stored in the schedule storing unit M3. In this example, the user's name and the course name are described in the table for a particular trainee, and additionally record data (sometimes referred to simply as “record”) for the trainee are recorded in time series. Each record contains lesson time information (A) which represents the time (date and hour) set for each lesson frame, lesson content or matter information (B) which represents the content or matter of the corresponding lesson frame, progress state information (C) (sometimes referred to simply as “progress information”) which represents the progress state of the corresponding lesson frame, and some other necessary supplementary note information. The progress state information (C) is set to be “to go” (this means that the lesson frame has not been taken or practiced yet) for every lesson frame initially when the schedule database Sd is prepared, and will be renewed to be “done” by the schedule controlling unit M4 when the user has achieved the lesson frame with a qualifying level.

The schedule controlling unit M4 is a function block of controlling the associated units to manage the progress of the lesson by the user. For example, the schedule controlling unit M4 periodically checks the contents of the schedule database Sd stored in the schedule storing unit M3, and picks out lesson time information (A) of the foremost record from among the records which include the progress state field of “to go,” and as the current time approaches the lesson time represented by the lesson time information (A), the schedule controlling unit M4 instructs the lesson providing unit M6 to give the scheduled musical lesson at the lesson time indicated by the record data. The training information Ti such as the music contents and the lesson programs necessary for providing the lesson by the lesson providing unit M6 may be sent beforehand in advance of the lesson or may be sent together with the instruction to give the lesson.

The schedule controlling unit M4 instructs the schedule notifying unit M5 to issue a “lesson schedule notice Ln” to the user reminding to take the scheduled lesson at the predetermined time point which is prior to the instruction to the lesson providing unit M6 to provide the lesson. Namely, the schedule controlling unit M4 sends an instruction to the schedule notifying unit M5 to issue the lesson schedule notice Ln at the predetermined time point which is prior to the lesson date and hour represented by the lesson time information (A) contained in the record that represents the nearest future (i.e. the foremost record among the records having the progress state information (C) of “to go”) in the schedule database Sd.

The time point for sending this instruction is determined based on the lesson date and hour represented by the lesson time information (A), more specifically, for example, (a) a predetermined hour before the lesson time of the lesson day (e.g. 8:00 PM of the scheduled day), (b) a predetermined amount of time in advance of the lesson time of the lesson day (e.g. one hour prior to or ten minutes prior to the lesson time) or else, as prepared beforehand to be determined by default. For determining the time point of sending the instruction to the lesson schedule notifying unit M5, the method of (a) above to issue a notice when the predetermined time comes or of (b) above to issue a notice when the current time comes to the time which is a predetermined amount of time prior to the lesson time, or both of the methods may be employed. Further, in either method of (a) and (b), notices may be issued a plurality of times instead of once. It is preferable that the user can select or modify the setting of the instruction time as to which method to employ or at which time or how much time in advance to instruct.

When the schedule controlling unit M4 receives the schedule modification request information Ci from the schedule modification accepting unit M7 based on the modification request such as the “lesson schedule modification requesting e-mail Cim” or the “lesson schedule modification request instructing data Cis” as will be described later, the schedule controlling unit M4 modifies the related schedule based on the request modification information Ci and changes the contents of the schedule data Sd stored in the schedule storing unit M3, and also instructs the schedule notifying unit M5 to issue a “modified schedule notice Lc” which represents at least the modified elements of the schedule.

The schedule controlling unit M4 renews or changes the schedule data according to the contents of the lesson status information Li supplied from the lesson providing unit M6. The lesson status information Li herein is the information which represents the operation status of the lesson providing unit M6 or represents the user's lesson status (evaluation result value, achievement degree) when the musical lesson has been given by the lesson providing unit M6. For example, when the lesson providing unit M6 has conducted a lesson, the progress state information (C) of the conducted lesson in the schedule data Sd is renewed to be “done” from “to go.” When the results of the lesson practice has not been satisfactory, the same lesson step should be repeated again and the remaining lesson steps will be shifted afterward, and when the user has done two or more steps at a time, the remaining steps will be shifted forward, thus the schedule will be modified. Further, in the case of lesson negligence where the lesson step has not been taken (i.e. the user has neglected the lesson step), the schedule database will be modified by shifting down the remaining lesson steps.

When the schedule has been modified as mentioned above, the schedule controlling unit M4 instructs the lesson providing unit M6 to give the lesson according to the rescheduled lesson steps. In conducting such schedule-modified lessons, the lesson contents such as the musical contents and the lesson programs to be used in conducting the musical lesson may be placed under the control of the schedule controlling unit M4 and may be supplied therefrom to the lesson providing unit M6 at the time the lesson is given, or alternatively, the lesson contents may be placed under the control of the lesson providing unit M6 and the schedule controlling unit M4 may merely instruct the lesson providing unit M6 which lesson contents to use.

The schedule notifying unit M5 is a function block of transmitting a lesson schedule notice Ln to the user according to the instruction from the schedule controlling unit M4 to so notify. The preferable communication method to transmit such notices will be to transmit the notices by an e-mail to a mobile-type user terminal UT possessed by the user, but other transmission methods may also be used such as the telephone and the facsimile.

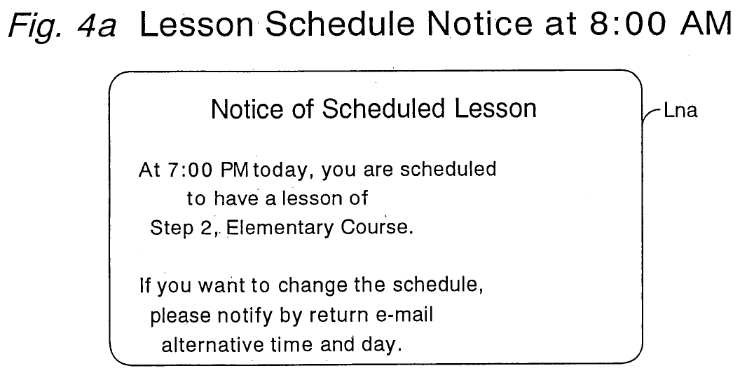

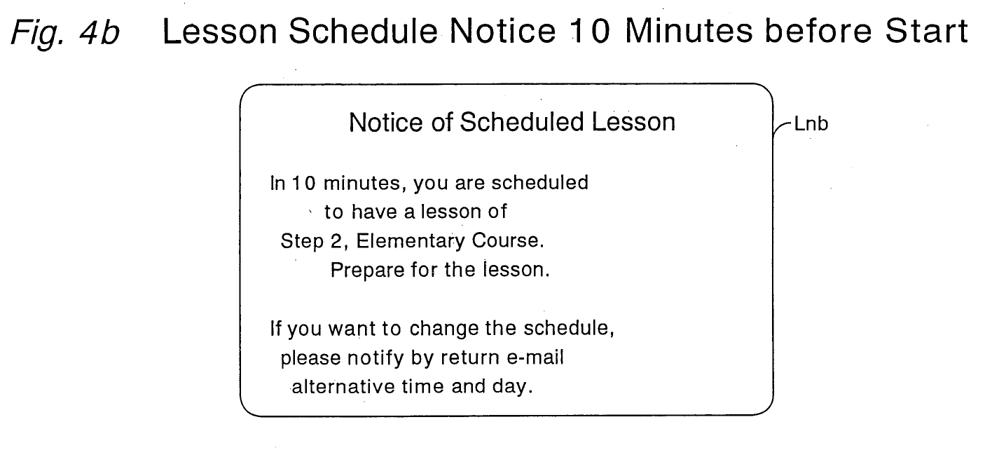

FIGS. 4a and 4b show examples of the lesson schedule notice Ln transmitted from the schedule notifying unit M5 in the musical training system to the user. FIG. 4a is an example of the lesson schedule notice Lna which is issued at a predetermined time point (e.g. 8:00 AM) before the scheduled lesson time (e.g. 7:00 PM) of the scheduled date, and FIG. 4b is an example of the lesson schedule notice Lnb which is issued at a time point which is a predetermined amount of time (e.g. ten minutes) in advance of the scheduled lesson data and hour. As shown in these Figs., the lesson schedule notices Lna and Lnb may preferably include a message to the effect that the system is ready to accept a request of changing the already set schedule from the user.

In order to notify a lesson schedule by means of an e-mail to the user terminal UT, the e-mail address of the user is registered in the musical training apparatus MT, and the musical training apparatus MT automatically will transmit an e-mail reminding the user to take the scheduled musical lesson to the registered e-mail address. In such a case, the e-mail address may preferably be of the user terminal UT such as a mobile cellphone which will be frequently checked for an e-mail arrival. Alternatively to an e-mail, the lesson schedule notice can be transmitted to the user by means of a telephone call sending a vocal (i.e. audio) message or by means of a facsimile sending a visual message. In addition, the lesson schedule notice may be given through the sound system 17 or the display device 16 of the musical training apparatus MT vocally or visually.

The lesson providing unit M6 is a function block of conducting a musical lesson of the designated lesson step according to the training information Ti from the schedule controlling unit M4, and will be started by the user's operation of the setting control 15 to initiate the lesson during the time period scheduled for the lesson of the intended step. The lesson providing unit M6 is ready to provide a musical lesson of the available steps beyond the step instructed by the schedule controlling unit M4.

The musical lesson modes to be conducted by the lesson providing unit M6 are, for example, the mode in which the musical contents for lesson contained in the training information Ti are played back by the sound system 17 and the display device 16, the mode in which the keys to be played are indicated by means of the guide lamps 16, the mode in which the actual performance data inputted through the play detection circuit 5 according to the music playing operation by the user of the music-playing device 14 is compared with the exemplary performance data contained in the musical contents for lesson to be evaluated, and so forth. The musical contents for lesson may include, for example, MIDI data (performance data), musical score data, key playing guide data, audio data (tone or voice (waveform) data), video data (image data), text data (character data), etc. The apparatus MT may communicate with the teacher terminal TT connected via the communication network CN to exchange performance data, tone or voice data, character data, image data, etc.

The lesson status information Li including the operation status of the lesson providing unit M6 and the user's lesson achievement (evaluation result) when the lesson providing unit M6 gave the musical lesson to the user is supplied to the schedule controlling unit M4, as described above, upon which the schedule controlling unit M4 executes the predetermined operations in response to the contents of the lesson status information Li.

For example, when the lesson status information Li tells that the lesson providing unit M6 did not conduct the scheduled lesson at the scheduled time and day (A), i.e. “the lesson negligence,” or that the lesson providing unit M6 did conduct the scheduled lesson but the lesson evaluation result was not satisfactory, the lesson providing unit M6 modifies the lesson schedule to shift down the remaining lesson steps.

On the contrary, when the lesson status information Li tells that the musical lesson was taken as scheduled with a satisfactory result, the schedule will not be modified, but the lesson to be taken next is shifted up by one step to prepare for the next step lesson. Further, in case the lesson status information Li shows the lesson result that the lesson has progressed by two steps or more, the schedule database will be modified so that the lesson steps will be shifted up by the amount of the progress.

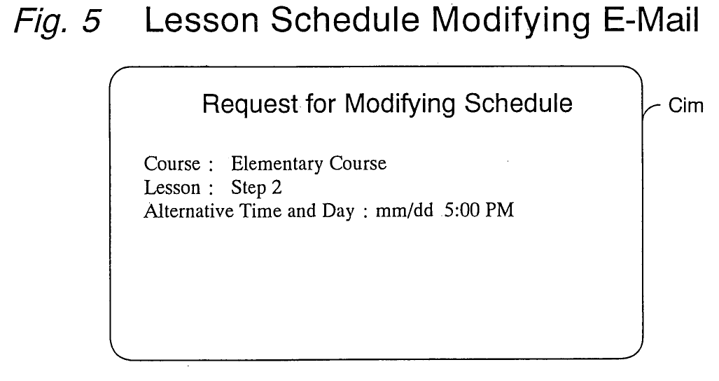

The schedule modification accepting unit M7 is a function block of accepting a schedule modification request from the user to modify the schedule and feeding back to the schedule controlling unit M4 a schedule modification request information Ci which represents the contents of the accepted schedule modification request. A request for modifying the schedule may be accepted in the form of a lesson modification requesting e-mail Cim from the user's e-mail terminal UT. FIG. 5 shows an example of the e-mail requesting a modification of a lesson schedule. In this example, the e-mail identifies the contents of lesson (B) in terms of the course name (e.g. elementary course) and the lesson name (e.g. step 2) and describes the date and hour when the user wishes to take the lesson. In the case where the musical training apparatus MT is to be used by plural users, the requesting e-mail should further contain the identification item of the user's name.

In place of a request by e-mail, a request for modifying the schedule can be made by directly inputting a lesson modification request commanding data Cis through the user's operations of the setting controls 15 (via 6) on the musical training apparatus MT. When a lesson modification requesting e-mail Cim is received from the e-mail terminal UT or a lesson modification requesting command Cis is inputted from the setting controls 15, the schedule modification accepting unit M7 supplies to the schedule controlling unit M4 a schedule modification request information signal Ci representing the contents of the schedule changes according to the lesson modification requesting e-mail Cim or lesson modification requesting command Cis.

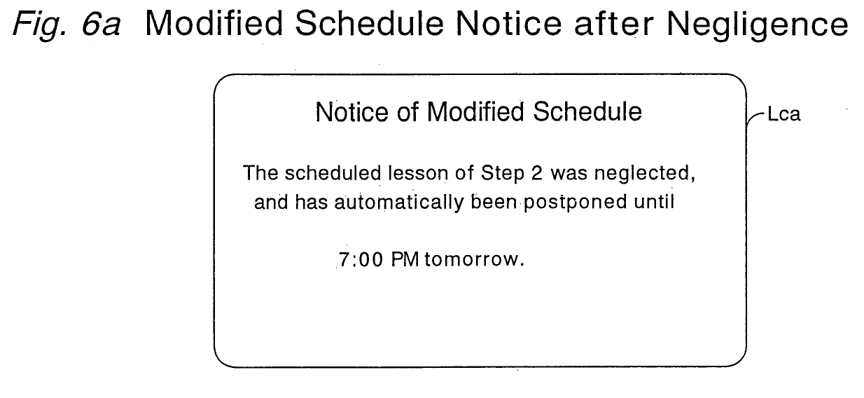

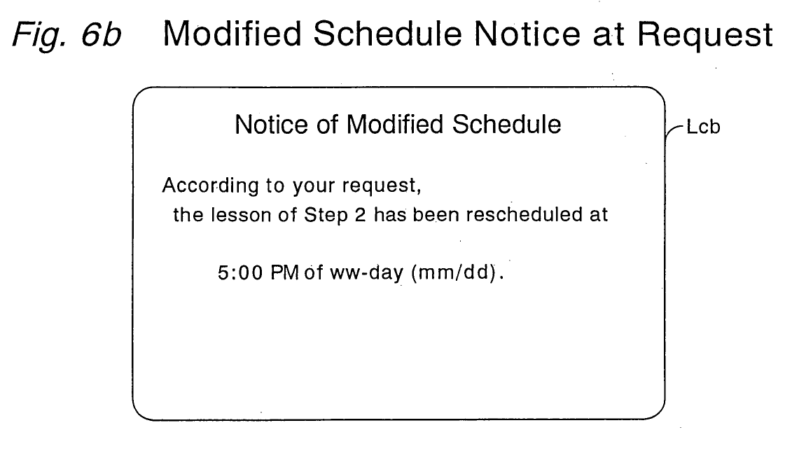

Thus, the schedule controlling unit M4 will modify the schedule data Sd in the schedule storing unit M3 in accordance with the contents of the lesson status information Li or of the schedule modification request information Ci, and let the schedule notifying unit M5 transmit a modified schedule notice Lc. FIGS. 6a and 6b show examples of the modified schedule notices, in which FIG. 6a is an example of the notice of the modified schedule Lca to be issued when the lesson status information Li means that the lesson was neglected and the lesson schedule has been postponed accordingly, and FIG. 6b is an example of the notice of the modified schedule Lcb to be issued when the schedule modification request information Ci is received and the lesson schedule has been changed to the date and hour as the user wishes.

Processing by Schedule Controlling Unit

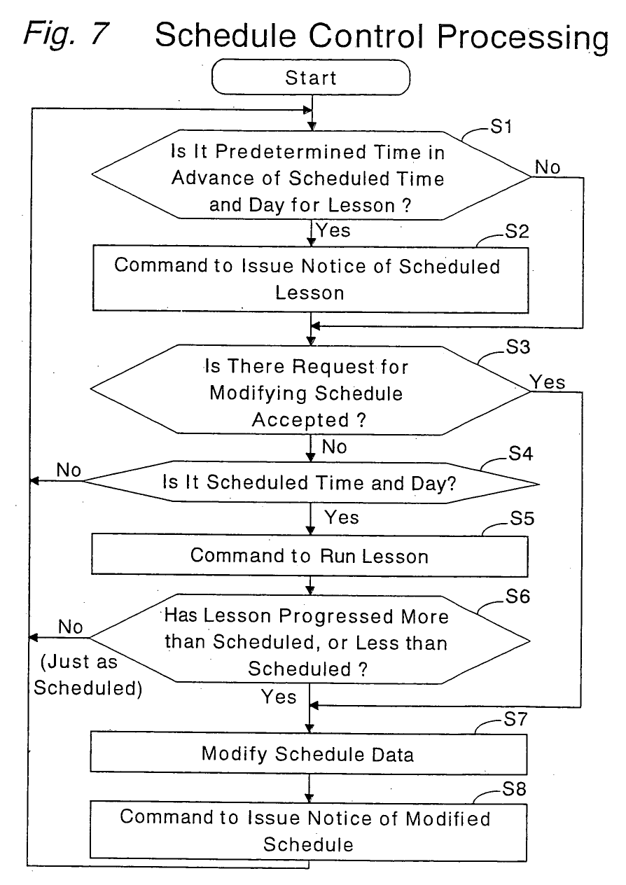

FIG. 7 is a flow chart describing the processing operation of the schedule controlling unit M4 according to an embodiment of the present invention. As the schedule controlling unit M4 is started, a step S1 checks the progress state information (C) in the schedule data Sd stored in the schedule storing unit M3 to find the earliest record among the schedule data records having the progress state (field C) of “to go”]placed in time series, and judges whether the current time is the predetermined time point before the lesson time (date and hour) as represented by the lesson time information (field A) in the above earliest record.

When the step S1 judges that the current time is such a predetermined time point, the judgment answer is “Yes,” and the process flow moves forward to a step S2 to command the schedule notifying unit M5 to issue a notice of scheduled lesson Ln to the user terminal UT, thereafter moving forward to a step S3. On the other hand, if the current time is not such a predetermined time point, the judgment answer is “No,” and the process flow skips directly to a step S3.

The step S3 judges whether the schedule modification request information Ci is inputted from the schedule modification accepting unit M7, that is, whether the schedule modification accepting unit M7 has accepted a request for lesson schedule modification. Where there is no request for lesson schedule modification accepted, the judgment here is negative (No), and the process moves forward to a step S4 to judge whether the current time point is the scheduled lesson time as contained in the data record for the lesson in question.

If the step S4 judges that the current time point is not the scheduled lesson time in question, the judgment answer is “No,” and the process flow goes back to the step S1 to start from the beginning. On the other hand, if the current time point is the scheduled lesson time in question, the judgment answer is “Yes,” and the process flow moves forward to a step S5.

The step S5 instructs the lesson providing unit M6 to conduct the musical lesson as nominated by the data record in question in the schedule database Sd, and the process flow moves forward to a step S6. The step S6 in turn judges whether the nominated musical lesson has been conducted off schedule or not, namely whether the lesson has proceeded ahead of or behind the schedule, or not (this means “on schedule”) based on the lesson status information Li from the lesson providing unit M6.

When the step S6 judges that the musical lesson has been conducted just as scheduled, the judgment answer is negative (No), and the schedule controlling unit M4 renews the progress state information (C) in the data record for the conducted lesson among the schedule database Sd stored in the schedule data storing unit M3, and rewrites the progress status data field (C) from “to go” to “done,” before going back to the step S1. Further, the schedule controlling unit M4 extracts the lesson results (e.g. evaluation value of the user's music playing) to be recorded out of the contents of the lesson status information Li according to necessity, and adds this extracted information to the data record of the lesson in question as supplemental lesson result information.

On the other hand, when the lesson progressed off schedule, that is, if the lesson has progressed more than scheduled or less than scheduled, the judgment at the step S6 is affirmative (Yes) and the process flow moves forward to a step S7. Also in the case where the step S3 judges that the schedule modification request information Ci is supplied from the schedule modification accepting unit M7, the process flow is directed to the step S7.

The step S7 modifies the schedule data Sd stored in the schedule data storing unit M3 in accordance with the contents of the lesson status information Li from the lesson providing unit M6 or of the schedule modification request information Ci from the schedule modification accepting unit M7. After the schedule modification processing at the step S7, the process flow moves forward to a step S8, and the schedule controlling unit M4 commands the schedule notifying unit M5 to notify the modified schedule, before going back to the step S1.

The preceding time point to be judged by the step S1 is the time point for sending a lesson schedule notice Ln to the user, and may be previously determined as (a) a specific hour before the scheduled lesson time (date and hour), or (b) a time point which is a predetermined amount of time prior to the scheduled lesson time (date and hour) as explained before. And in the following description, both of the time points (a) and (b) are employed in explaining the processing operation of the system in detail in connection with the regular lesson schedule notice and the modified schedule notice controlled by the schedule controlling unit M4 using the examples shown in FIGS. 3 through 6b.

(1) The Case Where There Is No Request for Schedule Modification

It is assumed here that, in the schedule database Sd of FIG. 3, the musical lesson scheduled to take place next is placed in the second record of the list, and also that the schedule modification accepting unit M7 has not accepted a request for modifying the schedule up until the start of the intended musical lesson. Then, the step S3 judges negative (No).

Under these circumstances, when the time becomes 8:00 AM of the day “m2/d2” on which the lesson of the second record (i.e. Step 2: Practice of right hand) will be taken, the step S1 of judging the preceding time point judges that the current time is the predetermined time (8:00 AM of the lesson day), i.e. the judgment is affirmative (Yes), and the schedule controlling unit M4 commands (at the step S2) the schedule notifying unit M5 to send a lesson schedule notice Lna as shown in FIG. 4a according to the contents of the second record, and then the process flow passes through the step S3 (with “No”) and the step S4 (with “No”) to return to the step S1 immediately.

Next, as the time becomes 6:50 PM of the day “m2/d2,” the step S1 of judging the preceding time point judges that the current time is the predetermined time (ten minutes before the lesson time), the judgment is affirmative (Yes), and the schedule controlling unit M4 commands (at the step S2) the schedule notifying unit M5 to send a final lesson schedule notice Lnb as shown in FIG. 4b according to the contents of the second record, and then the process flow passes through the step S3 (with “No”) and the step S4 (with “No”) to return to the step S1 immediately.

Further, as the time becomes 7:00 PM of the day “m2/d2,” the process flow passes through the step S1 (with “No”), the step S3 (with “No”) and the step S4 (with “Yes”) to come to the step S5. At the step S5, the schedule controlling unit M4 commands the lesson providing unit M6 to give the lesson of “Elementary course, Step 2 (practice of right hand)” as set in the second record. Thereafter, when the step S6 interprets the lesson status information Li from the lesson providing unit M6 and finds that the lesson has been conducted just as scheduled, the judgment answer at the step S6 is negative (No), then the schedule controlling unit M4 renews the progress state information (C) in the second record from “to go” to “done” and sets the third record to be the next scheduled lesson, before the process flow returns to the step S1. Subsequently, the schedule controlling unit M4 operates in the same manner as described above to issue lesson notices at 8:00 AM of the day “m3/d3” and so forth with respect to the third record and to conduct the lesson as set by the third record.

After the schedule controlling unit M4 has commanded the lesson providing unit M6, at the step S5, to conduct the scheduled lesson, if the scheduled lesson has not progressed just as scheduled, the judgment at the step S6 is affirmative (Yes), the schedule data Sd is modified at the step S7 according to the progress state of the lesson. For example, in the case where the lesson has progressed more than scheduled, the progress state information (C) in the records of the progressed lessons are respectively renewed and the lesson dates and hours in the records of the lessons scheduled thereafter will be successively shifted up. And in the case where the lesson has not progressed satisfactory (lesson achievement is not sufficient), or in the case where the lesson has not been conducted (the lesson has been neglected), that lesson is rescheduled at some appropriate date and hour which is before the next scheduled lesson date and hour, or the lesson dates and hours after that lesson will be successively shifted down.

The schedule controlling unit M4 then commands the schedule notifying unit MS, at the step S8, to issue a modified schedule notice Lc to the user according to the modified schedule data Sd. For example, in the case that the schedule lesson has been neglected, the schedule controlling unit M4 commands the schedule notifying unit MS to send a modified schedule notice as shown in FIG. 6a to the user. And thereafter, on the day for the next scheduled lesson according to the modified schedule database Sd, the lesson schedule notices will be issued and the lesson will be conducted according to the modified schedule database Sd as explained above.

(2) The Case where there is a Request for Schedule Modification

On the other hand, in the case where the schedule modification accepting unit M7 receives a lesson modification requesting e-mail Cim as shown in FIG. 5 and the request for modifying the schedule is accepted, the judgment at the step S3 is affirmative (Yes), and the system operates as follows.

The schedule controlling unit M4 modifies the schedule database Sd in accordance with the contents of the schedule modification request represented by the schedule modification request information Ci from the schedule modification accepting unit M7, and issues the lesson notices and conducts the lesson on the next scheduled lesson day according to the modified schedule database Sd in the manner as explained above.

The modification of the schedule will be determined according to the predetermined modification rules, wherein the schedule will be modified which meets the contents of the schedule modification request as long as such a modification will not affect the musical lessons to be conducted after the requested lesson. For example, as the modification request of FIG. 5 (the lesson day is mm/dd) does not affect the next lesson as set by the third record (the lesson day is m3/d3) (it is assumed here that mm/dd is the data before m3/d3), the lesson schedule will be modified just as requested, and the schedule controlling unit M4 commands the schedule notifying unit M5 to send a modified schedule notice Lcb as shown in FIG. 6b.

Operation Timing of the Processing

The above description of the processing flow was made about the case where the process flow returns to the preceding time checking step S1 every time the predetermined process is over for the simplicity of explanation, but in the practical system, the process flow may be normally brought to a standby state and the lesson schedule notification routine and the lesson conducting routine may be started by the timer according to the schedule data Sd, i.e. when the current time becomes the predetermined time point with respect to the date and hour of the next scheduled lesson in the schedule database Sd, the schedule controlling unit M4 commands the schedule notifying unit M5 to issue a lesson schedule notice, and when the current time becomes the schedule lesson time of that lesson, the schedule controlling unit M4 commands the lesson providing unit M6 to conduct that lesson.

Further, with respect to the step S3 of judging whether a request for modifying the schedule is accepted, the schedule modification accepting unit M7 may preferably be brought to a standby state normally in accepting a lesson modification requesting e-mail, and may preferably be activated by the timer periodically every predetermined period of time to acquire e-mails received and stored in the e-mail server, and if there is an e-mail Cim requesting for the lesson modification among the acquired e-mails, the judgment at the step S3 is affirmative (Yes) and then the steps S7 and S8 may be performed for the schedule modification before the process flow comes to a standby state again.

While particular embodiments of the invention and particular modifications have been described, it should be expressly understood by those skilled in the art that various modifications and substitutions may be made without departing from the spirit of the present invention so that the invention is not limited thereto, since further modifications may be made by those skilled in the art, particularly in light of the foregoing teachings. It is therefore contemplated by the appended claims to cover any such modifications that incorporate those features of these improvements in the true spirit and scope of the invention.

What is claimed is:

1. A musical training apparatus comprising:
a schedule managing device for managing a schedule database including lesson matter information representing lesson matters of musical lesson courses and lesson time information representing times to take lessons of said respective lesson matters in the form of a relational database, wherein each lesson time is assigned to each corresponding lesson matter for a user; and
a lesson schedule notifying device for notifying to a user terminal device a reminder of a scheduled lesson matter and the scheduled lesson time for the user to take said scheduled lesson matter at a predetermined time point in advance of said scheduled lesson time as represented by said lesson time information.

2. An apparatus as claimed in claim 1, wherein said schedule managing device modifies said schedule database in accordance with a progress state of the musical lesson course by the user.

3. An apparatus as claimed in claim 1, wherein said schedule managing device modifies said schedule database in accordance with a request from said user terminal device.

4. An apparatus as claimed in claim 2, wherein said schedule managing device modifies said schedule database in accordance with a request from said user terminal device.

5. An apparatus as claimed in claim 1, further comprising:
an initial setting device for setting initial items for a musical lesson, said items including at least one of a lesson starting date, a lesson frequency, a lesson time and a lesson content; and
a schedule arranging device for arranging a basic lesson schedule according to said items for a musical lesson set by said initial setting device, thereby composing a basic lesson schedule database as said schedule database.

6. A computer readable medium containing executable instructions for causing a computer to perform a method for managing schedule of lessons for musical training by a user, said method comprising the steps of:
providing a schedule database including lesson matter information representing lesson matters of musical lesson courses and lesson time information representing times to take lessons of said respective- lesson matters in the form of a relational database, wherein each lesson time is assigned to each corresponding lesson matter for a user; and
notifying to a user terminal device a reminder of a scheduled lesson matter and the scheduled lesson time for the user to take said scheduled lesson matter at a predetermined time point in advance of said scheduled lesson time as represented by said lesson time information.

7. A computer readable medium as claimed in claim 6, wherein said step of providing a schedule database includes the steps of:
setting initial items for a musical lesson, said items including at least one of a lesson starting date, a lesson frequency, a lesson time and a lesson content; and
arranging a basic lesson schedule according to said initial items for a musical lesson, thereby composing a basic lesson schedule database as said schedule database.
